(19) United States
(12) Patent Application Publication
(10) Pub. No.: US 2026/0153304 A1
(43) Pub. Date: Jun. 4, 2026

(54) TOY GUN

(71) Applicant: NINGBO SINCERE LEISURE PRODUCTS CO., LTD., Ningbo (CN)

(72) Inventor: Charley Lu, Ningbo (CN)

(21) Appl. No.: 19/026,506

(22) Filed: Jan. 17, 2025

(30) Foreign Application Priority Data
Nov. 29, 2024 (CN) 202411744764.1

(51) Int. Cl. F41B 7/08; A01K 15/02

(52) U.S. Cl. CPC F41B 7/08; A01K 15/025

(57) ABSTRACT

A toy gun includes a launching portion including a launching member, one end of the launching member is configured as a cavity and the cavity is configured to receive a toy; a bolt portion including a bolt member, a first claw buckle, a second claw buckle, and an adjusting assembly, the first claw buckle and the second claw buckle are coaxially rotatably connected to the bolt member, the first claw buckle comprises a first claw body and a second claw body, the adjusting assembly is connected to the bolt member, and one end of the adjusting assembly is abutted against the second claw buckle; and an engaging portion including a first ratchet and a second ratchet, the first ratchet are used for fitting the second claw body and the second ratchet are used for fitting the second claw buckle.

### CROSS-REFERENCE TO RELATED APPLICATIONS

This application claims priority to Chinese Patent Application No. 202411744764.1, filed on Nov. 19, 2024, the content of which is incorporated herein by reference in its entirety.

### TECHNICAL FIELD

The present disclosure relates to the technical field of toy guns, more particularly to a toy gun.

### BACKGROUND

At present, more and more people like to own pets. In order to make pets happy and exercise their jumping ability, people often buy ball toys for pets, such as netballs. It is affordable and has a long service life. The conventional ball toys on the market are generally suitable for playing at outdoors. The ball is thrown out mainly by hands, and then the pet picks up and chews the ball to realize the purpose of exercising the pet. However, the projection by hand has the problems of limited projection distance and a large amount of exercise, the effect of exercising the jumping force of the pet is not obvious, and the arm of the projector is sore, which is laborious and troublesome.

### SUMMARY

The purpose of the present disclosure is to provide a toy gun capable of launching toys, which is beneficial to realize the comprehensive effects of labor saving and gentle forcing, and improves the pleasure of interaction between users and pets.

The embodiment of the present disclosure provides a toy gun comprising: a launching portion comprising a launching member, where one end of the launching member is configured as a cavity and the cavity is configured to receive a toy; a bolt portion comprising a bolt member, a first claw buckle, a second claw buckle and an adjusting assembly, where the bolt member is arranged on a side of the launching member away from the cavity, the first claw buckle and the second claw buckle are coaxially rotatably connected to the bolt member, the first claw buckle comprises a first claw body and a second claw body, and when the first claw body is used for the launching member to accumulates energy, the launching member is pulled to move in a direction away from launching the toy, the adjusting assembly is connected to the bolt member, and one end of the adjusting assembly is abutted against the second claw buckle; and an engaging portion comprising a first ratchet and a second ratchet, where the first ratchet are used for fitting the second claw body and the second ratchet are used for fitting the second claw buckle; where when the launching member launches the toy, the first ratchet moves in a direction close to the second claw body to drive the first claw buckle to rotate about the bolt member to the first claw body to release the launching member, and when the launching distance of the launching member is adjusted, the adjusting assembly drives the second claw buckle to rotate about the bolt member, the second claw buckle is disengaged from the second ratchet and moves along the launching direction of the launching member to fit with the second ratchet at a predetermined position.

In the above implementing process, the bolt member is positioned at one side of the launching member, and one end of the bolt member is provided with a first claw buckle and a second claw buckle respectively, when the toy needs to be loaded, the toy is first placed in the cavity of the launching member, then an external force is applied to the bolt member, the bolt member pulls the launching member by the first claw buckle to move until the bolt portion moves to the predetermined position of the engaging portion, when an energy accumulation distance of the launching member is too large, the position of the second claw buckle relative to the second ratchet can be adjusted by the adjusting assembly to finally complete the energy accumulation process of the launching member, when the toy needs to be released, the first ratchet needs to be moved along the direction close to the second claw body, and the second claw body drives the first claw body to rotate relative to the bolt portion under the extrusion of the first ratchet until the first claw body releases the launching portion, and finally the launching member restores to an initial position under the action of the elastic assembly and launches the toy. The whole process is conducive to achieving the comprehensive effect of labor saving and gentle forcing, and improves the pleasure of interaction between users and pets.

In some embodiments, the launching portion further comprises an elastic assembly, the elastic assembly comprises a first fixed pulley, a first guide pulley, and an elastic member, one end of the elastic member is a fixed end, and the other end thereof is sequentially wound around the first fixed pulley and the first guide pulley, and connected to the launching member to accumulates energy for the launching member.

In the above implementing process, the elastic member is wound around the first fixed pulley and the first guide pulley, and one end of the elastic member is fixed to the launching member, so that the assembly is simple, the structural design is reasonable, the launching of the launching member to the toy is beneficial, the energy accumulation process is labor-saving and forcing-gentle, and the pleasure of interaction between users and pets can be improved.

In some embodiments, two of the elastic assemblies are arranged, and two of the elastic assemblies are arranged on opposite sides of the launching member.

In the above implementing process, by arranging two elastic assemblies, it is not only simple to assemble, but also beneficial to launching the toy by the launching portion, and once any one of the elastic assemblies is damaged, the launching of the toy gun will not be immediately unusable, thus greatly increasing the service life of the toy gun and reducing the number of replacement of consumables of the toy gun.

In some embodiments, the toy gun further comprises a noise reduction ring, the noise reduction ring is disposed on opposite sides of the launching member, and the launching member is disposed with a noise reduction rib, where when the launching member launches the toy, the noise reduction rib is fitted with the noise reduction ring, and when the elastic assembly accumulates energy on the launching member, the noise reduction rib is disengaged from the noise reduction ring.

In the above implementing process, the launching portion is provided with a noise reduction rib fitted with the noise reduction ring, and the noise reduction ring and the noise reduction rib can cooperate to decelerate the launching portion at the same time when the launching portion launches the toy, and crucially, the damping action stroke and time on the launching portion can be greatly delayed by setting the noise reduction ring, and there is no mechanical impact and vibration in the process, thus greatly reducing noise decibels, avoiding frightening to the pet when interacting with the pet, and improving the interaction pleasure.

In some embodiments, one side of the launching member facing away from the cavity is configured with a claw buckle groove, and the claw buckle groove is configured to fit with the first claw body when the launching member accumulates energy, and the claw buckle groove is disengaged from the first claw body when the launching member launches the toy.

In the above implementing process, one end of the launching member is provided with a claw buckle groove fitted with the first claw body, so that after the first claw body is fitted with the claw buckle groove, when the bolt member is pulled, the launching member can be driven to move along the direction away from the toy. At this time, the elastic assembly is gradually pulled until the bolt portion moves to the predetermined position of the engaging portion, and the energy accumulation process of the launching member is completed. When the toy needs to be launched, the first claw body needs to be disengaged from the claw buckle groove, and then the launching member restores to the initial position under the action of the elastic assembly. The whole process is beneficial to realize the comprehensive effect of labor saving and gentle forcing, and improves the pleasure of interaction between users and pets.

In some embodiments, the toy gun further comprises an energy accumulation assembly, one end of the energy accumulation assembly is connected to the launching member, the other end of the energy accumulation assembly is fitted with the first claw body when the launching member accumulates energy, and when the launching member launches the toy, the other end of the energy accumulation assembly is released by the first claw body.

In the above implementing process, the energy accumulation assembly is respectively connected to the launching member and the first claw body, which can save labor and increase the energy accumulation path at the same time, thereby increasing the working stroke. According to Hooke's law, the lower the energy accumulation coefficient, the longer the working stroke, and when the user is pulling, the force of the energy accumulation assembly will not increase sharply, thereby realizing a very gentle pulling force feeling, and the audience group of the toy gun will be greatly increased.

In some embodiments, the energy accumulation assembly comprises a pulley block and an energy accumulation member, the pulley block is configured in two sets, the two sets of the pulley blocks are located on two sides of the central axis of the bolt member, one end of the energy accumulation member is connected to one set of the pulley blocks, and the other end of the energy accumulation member is respectively wound around the two sets of the pulley blocks, and then fixed to the other set of the pulley blocks.

In the above implementing process, the energy accumulation member is wound to the pulley block, and by increasing the number of pulleys of the pulley block, the energy accumulation member can obtain a longer energy accumulation path, and the longer length of the energy accumulation member can increase the working stroke, so that when the user is pulling, the force of the energy accumulation member will not increase sharply, so that a very gentle pulling force feeling is realized, and the audience group of the toy gun will be greatly increased.

In some embodiments, the toy gun further comprises a trigger assembly, one end of the trigger assembly is in contact with one side of the first ratchet facing away from the second claw body to drive the first ratchet to move in a direction close to the second claw body when the trigger assembly is pulled.

In the above implementing process, the trigger assembly is in contact with the first ratchet, so that when the trigger assembly is pulled, the second claw body can be driven to rotate relative to the bolt portion by the first ratchet, and then the first claw body can release the launching portion to complete the launching of the toy. The trigger assembly is simple in structure, and reduces the difficulty of assembly, thereby reducing the setting arrangement of fine structures, the structure is more integrated and has a more firm and stable effect, and the detachment, wear, and stuck of components are not easy to occur.

In some embodiments, the toy gun further comprises a guy shell configured to receive a partial structure of the bolt portion, the launching portion, and the engaging portion.

In some embodiments, a guide member is configured inside the guy shell, and the guide member is configured with a guide surface configured to contact one side of the first ratchet facing away from the second claw body, for lifting the first ratchet when the launching member accumulates energy.

In the above implementing process, by arranging the guide member inside the gun shell, when the trigger assembly is pulled, the first ratchet can move along the guide surface of the guide member to gradually lift the second claw body and drive the first claw body to move to release the launching member. The structure is simple, the difficulty of assembly is reduced, the setting arrangement of fine structures is reduced, the structure is more integrated, the effect is firmer and more stable, and the detachment, wear, and stuck of components are not easy to occur.

Other features and advantages of the present disclosure will be set forth in the following specification, or some of the features and advantages may be inferred or unquestionably determined from the specification, or may be learned by practicing the above-described techniques of the present disclosure.

In order to make the above objects, features, and advantages of the present disclosure more readily understood, the embodiments will be described in detail below with reference to the accompanying drawings.

### BRIEF DESCRIPTION OF THE DRAWINGS

In order to more clearly explain the technical solutions of the embodiments of the present disclosure, the following drawings that need to be used in the embodiments of the present disclosure will be briefly introduced. It should be understood that the following drawings only illustrate certain embodiments of the present disclosure, and therefore should not be regarded as limiting the scope. For those skilled in the art, other related drawings can be obtained from these drawings without making creative labor.

FIG. 1 is a perspective view of a toy gun provided by an embodiment of the present disclosure.

FIG. 2 is a sectional view of the toy gun provided by the embodiment of the present disclosure.

FIG. 3 is a perspective view of part of toy gun provided by the embodiment of the present disclosure.

FIG. 4 is a sectional view of the toy gun provided by the embodiment of the present disclosure.

FIG. 5 is a schematic structural diagram of the launching portion and the bolt portion of the toy gun according to the embodiment of the present disclosure.

FIG. 6 is a sectional view of the adjusting assembly of the toy gun provided by the embodiment of the present disclosure.

FIG. 7 is a sectional view of the adjusting assembly of the toy gun provided by the embodiment of the present disclosure.

FIG. 8 is a schematic diagram illustrating the connection between another launching portion and the bolt portion of the toy gun provided by the embodiment of the present disclosure.

FIG. 9 is a sectional view illustrating the disengagement of the launching portion and the bolt portion of the toy gun according to the embodiment of the present disclosure.

FIG. 10 is a sectional view illustrating the disengagement of the second claw and the second ratchet of the toy gun provided by the embodiment of the present disclosure.

### DETAILED DESCRIPTION OF THE EMBODIMENTS

Hereinafter, the technical solutions in the embodiments of the present disclosure will be clearly and completely described with reference to the accompanying drawings in the embodiments of the present disclosure, and it is obvious that the described embodiments are only a portion of the embodiments of the present disclosure, but not all the embodiments. The components of the embodiments of the present disclosure generally described and illustrated in the drawings herein may be arranged and designed in a variety of different configurations. Accordingly, the following detailed description of embodiments of the disclosure provided in the accompanying drawings is not intended to limit the scope of the claimed disclosure, but is merely to represent selected embodiments of the disclosure. Based on the embodiments of the present disclosure, all other embodiments obtained by those skilled in the art without making creative work belong to the scope of protection of the present disclosure.

In the present disclosure, the orientation or positional relationship indicated by the terms “upper”, “lower”, “left”, “right”, “front”, “back”, “top”, “bottom”, “inner”, “outer”, “middle”, “vertical”, “horizontal”, “longitudinal” and the like is based on the orientation or positional relationship shown in the drawings. These terms are primarily intended to better describe the disclosure and embodiments thereof and are not intended to limit that the indicated device, element, or member must have a specific orientation, or be constructed and operated in a specific orientation.

Moreover, some of the above terms may be used to mean other meanings in addition to orientation or positional relationships, for example, the term “on” may also be used to mean some kind of attachment or connection relationship in some cases. The specific meanings of these terms in the present disclosure can be understood by those of ordinary skill in the art according to the specific circumstances.

Furthermore, the terms “mounted”, “provided”, “connected”, and “disposed” are to be understood broadly. For example, it may be a fixed connection, a detachable connection, or a monolithic construction; may be a mechanical connection or a point connection. It may be directly connected, indirectly connected through an intermediate medium, or internal communication between two devices, elements, or members. Those skilled in the art can understand the specific meanings of the above-mentioned terms in the present disclosure according to the specific circumstances.

Furthermore, the terms “first”, “second”, and the like are primarily used to distinguish between different devices, elements, or members (specific kinds and configurations may or may not be the same), and are not intended to indicate or imply the relative importance and the number of indicated devices, elements, or members. Unless otherwise specified, “a plurality of” means two or more.

In the present disclosure, the toy gun provided by the embodiment can be used to launch a toy 80, and the toy 80 comprises but is not limited to a sphere, for example, the sphere can be a tennis ball, a ping pong ball, or the like, and can be used for interaction between a user and a pet, so as to realize the purpose of exercising the pet, and increase the interaction pleasure.

The toy gun of the present disclosure comprises a launching portion 10 for receiving the toy 80, a bolt portion 20, and an engaging portion 30. The bolt portion 20 is used for pulling the launching portion 10 to a predetermined position, to complete the energy accumulation process of the launching portion 10 (that is, the bolt portion 20 is used to assist the launching member 101 of the launching portion 10 to complete the energy accumulation of the toy gun through the elastic assembly 103). The engaging portion 30 is engaged with the bolt portion 20, and when an external force is applied to the engaging portion 30, the release of the bolt portion 20 to the launching portion 10 can be realized, and then the launching portion 10 launches the toy 80.

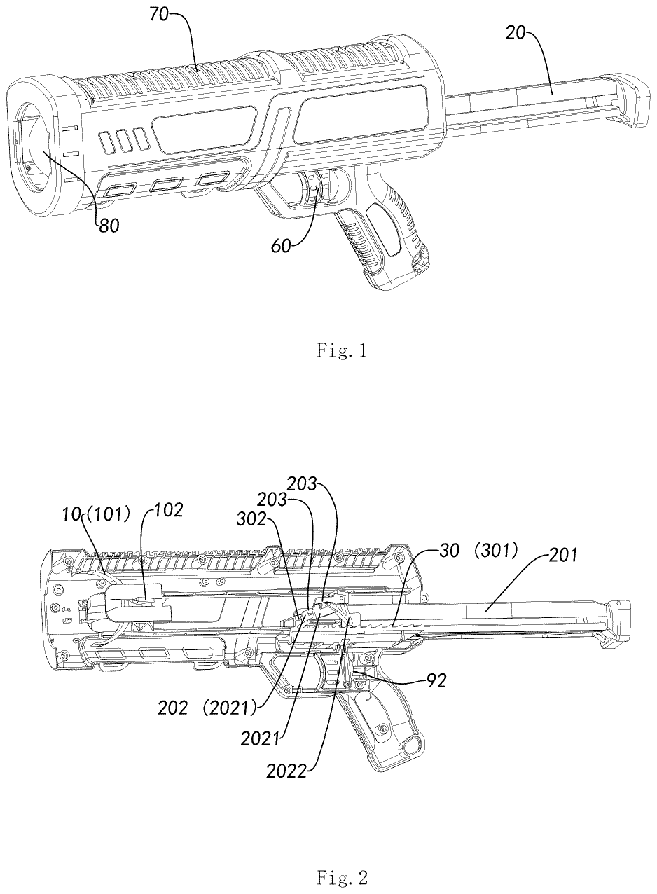

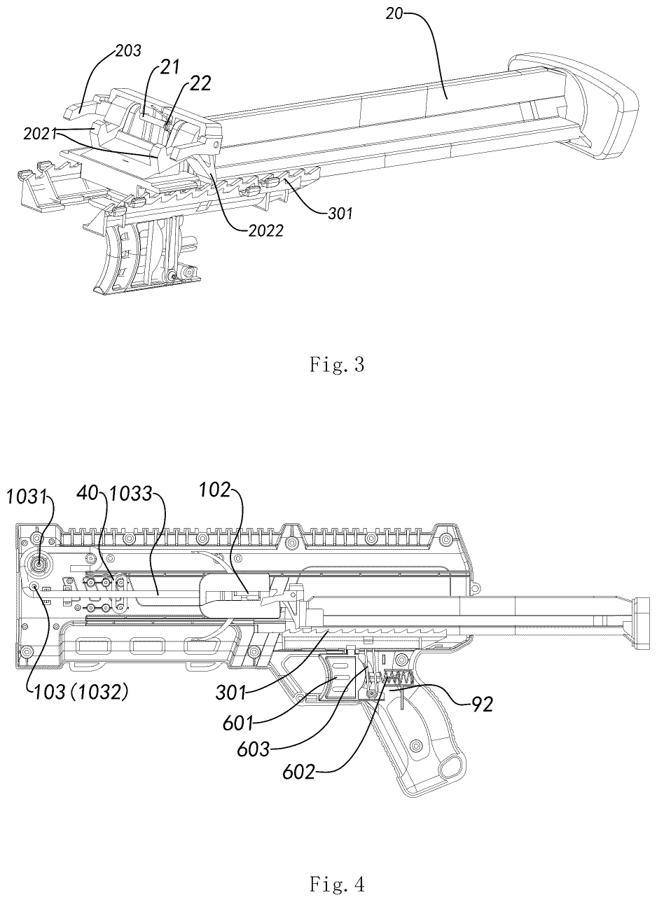

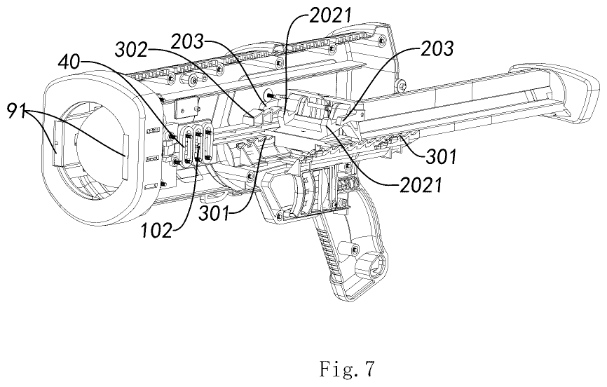

Specifically, as shown in FIGS. 1 to 10, the embodiment of the present disclosure provides a toy gun comprising: a launching portion 10 comprising a launching member 101, where one end of the launching member 101 is configured as a cavity and the cavity is configured to receive the toy 80; a bolt portion 20 comprising a bolt member 201, a first claw buckle 202, a second claw buckle 203, and an adjusting member, where the bolt member 201 is arranged on the side of the launching member 101 facing away from the cavity, the first claw buckle 202 and the second claw buckle 203 are coaxially rotated and connected to the bolt member 201, the first claw buckle 202 comprises a first claw body 2021 and a second claw body 2022, the first claw body 2021 is used to pull the launching member 101 to move away from the direction for launching toy 80 when the launching member 101 accumulates energy, the adjusting assembly is connected to the bolt member 201, and one end of the adjusting assembly is connected against the second claw buckle 203; and an engaging portion 30 comprising a first ratchet 301 and a second ratchet 302, where the first ratchet 301 is positioned in the cavity inside the gun shell, the second ratchet 302 is positioned on the inner side wall of the gun shell, the first ratchet 301 moves when the trigger is pulled, the second ratchet 302 is fixedly arranged, the first ratchet 301 is used for fitting the second claw body 2022, and the second ratchet 302 is used for fitting the second claw buckle 203. When the launching member 101 launches the toy 80, the first ratchet 301 moves along the direction close to the second claw body 2022 to drive the first claw buckle 202 to rotate around the bolt member 201 to the first claw body 2021 to release the launching member 101. When adjusting the launching distance of the launching member 101, the adjusting assembly drives the second claw buckle 203 to rotate around the bolt member 201, the second claw buckle 203 is disengaged from the second ratchet 302 and moves along the launching direction of the launching member 101 to fit with the second ratchet 302 at the predetermined position.

Exemplarily, the launching member 101 comprises a plurality of launching claws arranged along the circumference of the launching member 101, the launching claws can be used to receive the toy 80 to be launched. The inner contour of the launching claws is shaped in a semi-circular arc (or other related shape), and the diameter of the semi-circular arc depends on the size of the toy 80 to be launched. It can be understood that the semi-circular arc can be used to receive a toy 80 of one size, and of course, the inner contour of the semi-circular arc can be provided in a stepped manner, so that the outermost circular arc has a larger diameter ball receiving space, and the innermost circular arc has a smaller ball receiving space. This arrangement can make it possible to play a plurality of toys 80 with different diameters using one launching member 101, which has the advantage of using diversified toys 80.

Further, in order to easily pick the ball up, at least two blocking strips 91 are provided at the launching outlet. The blocking strips 91 are located at two sides symmetrically. The shapes of the blocking strips 91 are set to a rectangular shape or similar shape. The blocking strips 91 have a certain length b perpendicular to the launching direction, and assuming that the diameter of the launching outlet is approximately equal to the diameter A of the toy ball, then the net distance between the two blocking strips 91 is A−2b; The blocking strips 91 have a certain thickness parallel to the launching direction, which makes the blocking strips 91 have a certain toughness. Based on this setting, when the user holds the toy gun and loads the toy 80 on the ground, such as the sphere, only needs to hold the toy gun, the sphere that the launching outlet is towards the ground, advances slightly hard, the sphere enters the launching outlet after overcoming the resistance of the blocking strips 91, even if the user lifts the toy gun far away from the ground at this moment, because the self-weight of the toy ball cannot overcome the deformation resistance of the blocking strips 91, thereby does not fall out of the launching outlet freely, and when launching, the launching impulse force is much greater than the deformation resistance of the blocking strips 91, so that the sphere can pass through the blocking strips 91 smoothly and complete the launching move.

Optionally, the length b size of the blocking strips 91 can be set to 1 mm>b>15 mm. The material of the blocking strips 91 can be an elastic soft rubber material, such as a silicone sheet and the like.

For the structure of the bolt portion 20, the bolt portion 20 further comprises a connecting shaft 21, the connecting shaft 21 is respectively provided with the bolt portion 201, the first claw buckle 202, and the second claw buckle 203 therethrough, and the connecting shaft is further sleeved with a reset torsion spring 22, the reset torsion spring 22 can be used to abut against the second claw buckle 203 and can form a certain pre-tightening degree when the adjusting assembly adjusts the second claw buckle 203, to ensure the second claw buckle 203 restores to the initial position after adjusting under the torsion force of the reset torsion spring 22. It is worth to mention that, in order to realize the launching process and energy accumulation process of the launching member 101, the number of the claw buckles of the first claw buckle 202 (that is, the first claw body 2021 and the second claw body 2022) are two, and the number of claw buckles of the second claw buckle 203 are two. The two first claw buckles 202 are located between the two second claw buckles 203. Correspondingly, the first ratchets 301 are two and the second ratchets 302 are two, and two ends of the connecting shaft 21 are provided with threads, and the threads are threadedly connected with the second claw buckle 203.

As shown in FIG. 6, the adjusting assembly comprises an adjustment switch 204 and a linkage rod 205, the adjusting switch 204 is connected to the linkage rod 205, and the arrangement direction of the linkage rod 205 is consistent with the arrangement direction of the bolt member 201, the linkage rod 205 is located inside the bolt member 201, and one end of the linkage rod 205 facing away from the adjusting switch 204 is abutted against the claw buckle. In practical implement, for example, when the user thought that the current engagement position of the bolt portion 20 and the engaging portion 30 is backward, resulting in excessive energy, the linkage rod 205 can extrude the second claw buckle 203 by pressing and holding the adjusting switch 204, so that the second claw buckle 203 is released from the locked state, and the position of the bolt member 201 is moved towards the direction of the muzzle (the muzzle is used for launching the toy 80) until the user's hand is released when it is moved to a suitable position, and the locking of the second claw buckle 203 and the second ratchet 302 is realized again under the torsion force of the reset torsion spring 22.

In the above implementing process, the bolt member 201 is located on one side of the launching member 101, and the one end of the bolt member 201 is respectively provided with the first claw buckle 202 and the second claw buckle. When the toy 80 needs to be loaded, the toy 80 is first placed in the cavity of the launching member 101, then an external force is applied to the bolt member 201, the bolt member 201 drives the launching member 101 to move by the first claw buckle 202, until the bolt portion 20 moves to the predetermined position of the engaging portion 30. When an energy accumulation distance of the launching member 101 is too large, the position of the second claw buckle 203 relative to the second ratchet 302 can be adjusted by the adjusting assembly to finally complete the energy accumulation process of the launching member 101. When the toy 80 needs to be released, the first ratchet 301 needs to be moved along the direction close to the second claw body 2022, and the second claw body 2022 drives the first claw body 2021 to rotate relative to the bolt member 201 under the extrusion of the first ratchet 301, until the first claw body 2021 releases the launching member 101, and finally the launching member 101 restores to the initial position under the action of the elastic assembly 103, and completes the launching of the toy 80. The whole process is conducive to achieving the comprehensive effect of labor saving and gentle force and improving the pleasure of interaction between users and pets.

As shown in FIGS. 2 to 5, the launching portion 10 further comprises an elastic assembly 103, the elastic assembly 103 comprises a first fixed pulley 1031, a first guide pulley 1032, and an elastic member 1033, one end of the elastic member 1033 is a fixed end, and the other end of the elastic member 1033 is sequentially wound around the first fixed pulley 1031 and the first guide pulley 1032 and connected to the launching member 101 to accumulates energy for the launching member 101.

Exemplarily, the first fixed pulley 1031 and the first guide pulley 1032 are arranged at different positions of the toy gun, for example, the first fixed pulley 1031 is positioned above the first guide pulley 1032, so that when the elastic member 1033 is wound around the first fixed pulley 1031 and the first guide pulley 1032, the elastic member 1033 is in a tensioning state after installation, and the length of the elastic member 1033 can be increased by changing the arrangement position of the elastic member 1033, so that the force on the elastic member 1033 will not increase sharply, and the user pulls the bolt member 201 with longer elastic member 1033 to apply pulling force smoothly. The elastic member 1033 may be an elastic cord or an elastic drawstring.

In the above implementing process, the elastic member 1033 is wound around the first fixed pulley 1031 and the first guide pulley 1032, one end of the elastic member 1033 is fixed to the launching member 101, and the other end of the elastic member 1033 is fixed to the suitable position of the inner wall formed by the launching portion 10 and the bolt portion 20 of the toy gun. The whole assembly is simple, the structural design is reasonable, the launching of the launching member to the toy is beneficial, the energy accumulation process is labor-saving and forcing-gentle, and the pleasure of interaction between users and pets can be improved.

In some embodiments, the elastic assemblies 103 are at least two sets, each set of elastic assemblies 103 is provided with at least one elastic member 1033. One end of the elastic member 1033 is connected to the launching member 101, and the other end is connected to the fixing point of the inner cavity of the cavity portion. The two sets of elastic assemblies 103 are arranged on opposite sides of the launching member 101, that is, the two elastic assemblies 103 are symmetrically arranged along the central axis of the launching member 101, and the arrangement direction of the central axis is the length direction of the launching member 101.

In the above implementing process, by arranging two elastic assemblies 103, it is not only simple to assemble, to reduce the assembly difficulty of the user, but also beneficial to launching the toy 80 by the launching portion 101, and once any one of the elastic assemblies 103 is damaged, the launching of the toy gun will not be immediately unusable, since the one elastic assembly can still properly maintain the elastic function, thus greatly increasing the service life of the toy gun and reducing the number of replacement of consumables of the toy gun.

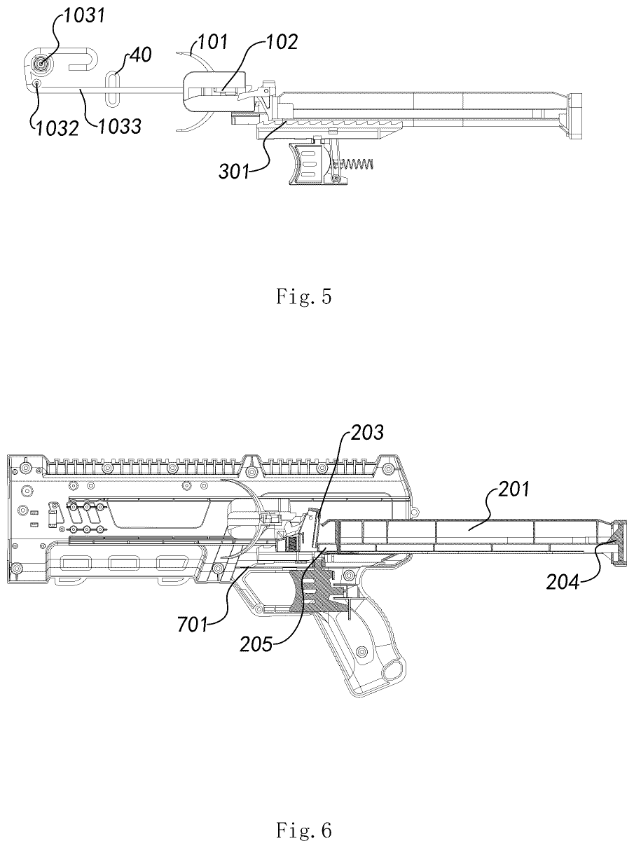

As shown in FIGS. 4-5, the toy gun further comprises a noise reduction assembly comprising a noise reduction ring 40 and a noise reduction rib 102, the noise reduction ring 40 is arranged on opposite sides of the launching member 101 (on the inner shell of the toy gun), and the launching member 101 is provided with the noise reduction rib 102, where when the launching member 101 launches the toy 80, the noise reduction rib 102 is fitted with the noise reduction ring 40, to pull the launching member 101 ejected at high speed, so that the toy 80 is disengaged from the launching member 101. When the elastic assembly 103 accumulates energy to the launching member 101, the noise reduction rib 102 is disengaged from the noise reduction ring 40, and the noise reduction rib 102 is fitted to contact with the noise reduction ring 40 during the launching process, so that the speed of the launching member 101 is continuously reduced to zero.

More specifically, the relative distance between the two noise reduction rings 40 facing each other on side walls is larger than the size of the element of the launching member 101 other than the noise reduction rib 102 in the relative direction, i.e. capable of receiving other elements of the launching member other than the noise reduction rib 102, but less than the maximum length distance of the two noise reduction ribs 102 in the relative direction, which is defined as the direction perpendicular to the launching direction. Thus, in the launching process of the launching member 100, only the noise reduction rib 102 can contact the noise reduction rib 40, the other position of the launching member 101 can pass through the position between the noise reduction rings without blocking by the noise reduction ring 40.

Exemplarily, at least one row of noise reduction rings 40 (comprising but not limited to elastic rubber rings) are symmetrically arranged along the central axis direction of the launching member 101 (i.e., at least one row of noise reduction rings 40 is arranged on each side of the launching member 101), and arranged at intervals along the length direction of the launching member 101 at each row. A plurality of noise reduction rings 40 are positioned in the travel route of the launching member 101 to rebound the toy 80, each noise reduction ring 40 is fixed near the gun shell 70 of the toy gun by two upper and lower fixing members, the noise reduction ring 40 forms an oval stadium structure layout, the fixing members comprises but are not limited to fixing bolts, the noise reduction ring 40 is sleeved on the fixing bolts and fastened by bolts, so that the noise reduction ring 40 is closer to the gun shell 70 relative to the launching claw.

In the above implementing process, the launch member 101 is provided with the noise reduction rib 102 fitted with the noise reduction ring 40, which can cooperate with the noise reduction rib 102 to decelerate the launch member 101 when the launch member 101 launches the toy 80. And crucially, the damping stroke of the launch member 101 can be greatly prolonged and the damping time of the launch member 101 can be delayed by setting the noise reduction rib 40. And since the noise reducing rib 102 is in contact with the noise reducing ring 40, the part of the noise reducing ring 40 that is in contact with the noise reducing rib 102 can be pulled to decelerate, so that the speed of the noise reducing rib 102 can be continuously reduced to zero, the energy is fully released, and the speed will not be reduced to zero in a cliff-like manner. Therefore, there is no violent mechanical impact and vibration in this process (that is, different from the traditional hard spring or the noise reduction buffer structure with fixed stop point), which greatly reduces the noise decibel, makes the user and the pet almost feel no noise, avoids frightening the pet when interacting with the pet, and improves the interaction pleasure between users and pets.

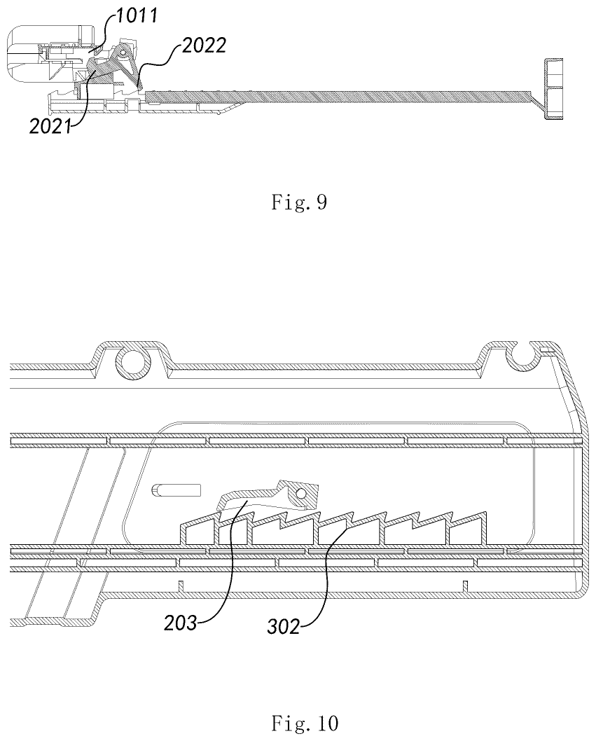

As shown in FIG. 9, a claw buckle groove 1011 is disposed on the side of the launching member 101 facing away from the cavity, and the claw buckle groove 1011 is disposed to fit with the first claw body 2021 when the launching member 101 accumulates energy, and the claw buckle groove 1011 is disengaged from the first claw body 2021 when the launching member 101 launches the toy 80.

In the above implementing process, one end of the launching member 101 is provided with a claw buckle groove 1011 fitted with the first claw body 2021, so that after the first claw body 2021 is fitted with the claw buckle groove 1011, when the bolt member 201 is pulled, the launching member 101 can be driven to move along the direction away from the toy 80. At this time, the elastic assembly 103 is gradually stretched until the bolt portion 20 moves to the predetermined position of the engaging portion 30, and the energy accumulation process of the launching member 101 is completed. When the toy 80 needs to be launched, the first claw body 2021 needs to be disengaged from the claw buckle groove, and then the launching member 101 is restored to the initial position under the action of the elastic assembly 103, and the whole process is conducive to realizing the comprehensive effect of labor saving and gentle forcing, and improving the pleasure of interaction between users and pets.

In another implementation, the arrangement of the elastic assembly can be varied appropriately to account for the effect of more labor-saving and balanced applying force. The conventional launching gun is not friendly enough to weak people (such as children, the elderly, etc.), mainly because in order to achieve better elastic effect, it is bound to use elastic rope with higher elastic coefficient to ensure sufficient elastic distance. However, elastic members with higher elastic coefficient will cause obstacles to the use of weak people. In the disclosure, the elastic assembly can be upgraded and replaced, and by using the combination of a plurality of pulleys, the labor-saving effect can be realized, and the elastic force of the elastic member can be maintained basically constant during the pulling process.

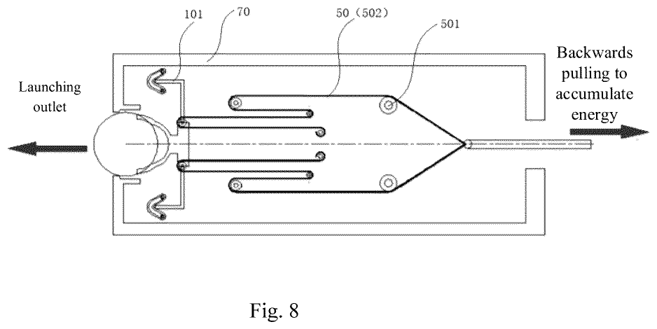

The solution can be as shown in FIG. 8. In this embodiment, the elastic assembly 103 of the toy gun comprises an energy accumulation assembly 50 and a plurality of pulley components, and the number of energy accumulation assemblies 50 is still two, where the launching member 101 is further provided with two pulley components, and the pulley components on the launching member 101 move together with the launching member 101 when pulling to accumulates energy or launching. One end of each energy accumulation assembly 50 is fixedly connected to the end of the rearward pull bolt, extended from the end of the bolt to one or more second guide pulleys 501 arranged in the gun shell, and then winds through the pulley components on the launching member 101, and then extended to a fixed connection point in the inner cavity of the gun shell. By the rearward pull bolt to stretch and accumulates energy, pulling the trigger and directly releasing the rearward pull bolt, the launching action can be completed quickly and concisely.

In the above implementation process, the energy accumulation assembly 50 is respectively connected to a plurality of pulley components, and the arrangement of the plurality of pulley components can realize the length of the energy accumulation assembly 50. According to Hooke's law f=kx, the longer elastic energy accumulation assembly has a lower elastic coefficient, which can effectively suppress the sharp increase of the f value during elastic pulling. In addition, in this embodiment, two pulleys are provided on the launching member 101, and these two pulleys can move together with the launching member 101, which essentially has a good effect of moving pulleys. In the former embodiment of the present disclosure, if the driving force of f is to be applied to the launching member 101, the force for pulling the bolt by the human hand is at least f/2 (so that the two elastic members 1033 have f/2 each, which is combined to be f), whereas in the present embodiment, if the driving force of f is to be applied to the launching member 101, the force for pulling the bolt by the human hand is about f/4, which leads to a saving of about 50% of the force for the human hand. And because the multi-pulley creates a longer elastic stroke and a lower elastic coefficient, it is also possible to maintain substantially f/4 manual force during pulling the bolt. When the user is pulling, the force of the energy accumulation assembly 50 will not increase sharply, thereby realizing a very gentle pulling force feeling, and the audience group of the toy gun will be greatly increased.

In some embodiments, the energy accumulation assembly 50 comprises a pulley block and an energy accumulation member 502, the pulley blocks are two sets, the two sets of pulley blocks are located on two sides of the central axis of the bolt member 201, one end of the energy accumulation member 502 is connected to one set of pulley blocks, and the other end of the energy accumulation member 502 is respectively wound to the two sets of pulley blocks, and then fixed to the fixed connection point in the gun shell.

Specifically, the energy accumulation member 502 comprises but is not limited to an elastic rope, and the energy accumulation assembly 50 can further comprise a plurality of second guide pulleys 501, and the plurality of second guide pulleys 501 are staggered at different heights of the gun shell 70, thereby further increasing the winding length of the energy accumulation member 502, and two sets of pulley blocks are provided, and the two sets of pulley blocks are wound by one energy accumulation member 502, which can save labor by about 50%.

Of course, in this embodiment, the toy gun further comprises a silent adhesive tape, and the silent adhesive tape is used to contact the launching member 101 when launching, thereby reducing noise during launching.

In the above implementing process, the energy accumulation member 502 is wound to the pulley block, and by increasing the number of pulleys of the pulley block, the energy accumulation member 502 can obtain a longer energy accumulation path, and the longer length of the energy accumulation member 502 can increase the working stroke, so that when the user is pulling, the force of the energy accumulation member 502 will not increase sharply, so that a very gentle pulling force feeling is realized, and the audience group of the toy gun will be greatly increased.

In some embodiments, the toy gun further comprises a handle portion 92, and the handle portion 92 comprises a trigger assembly 60. When the energy accumulation of the launching member 101 is completed, the trigger assembly 60 is pulled to trigger the launching action. The trigger assembly 60 comprises a trigger member 601, a reset torsion spring 22, and a return elastic cord 603, etc., and the trigger member 601 is respectively connected to the reset torsion spring 22 and the return elastic cord 603. One end of the trigger member 601 of the trigger assembly 60 is in contact with the side of the first ratchet 301 facing away from the second claw body 2022, so that when the trigger member 601 of the trigger assembly 60 is pulled, the first ratchet 301 is driven to move in a direction close to the second claw body 2022.

In the above implementing process, the trigger assembly 60 is in contact with the first ratchet 301, so that when the trigger assembly 60 is pulled, the first ratchet 301 can drive the second claw body 2022 to rotate relative to the bolt member 201, and then the first claw body 2021 can release the launching member 101 to complete the launching of the toy 80. The structure of the trigger assembly 60 is simple, the difficulty of assembly is reduced, the setting arrangement of fine structures is reduced, the structure is more integrated, the effect is firmer and more stable, and the detachment, wear, and stuck of components are not easy to occur.

In some embodiments, the toy gun further comprises a guy shell 70 configured to receive a partial structure of the bolt portion 20, the launching portion 10, and the engaging portion 30.

Referring again to FIG. 6, a guide member 701 is disposed inside the gun shell 70, and the guide member 701 is disposed with a guide surface disposed to be in contact with the side of the first ratchet 301 facing away from the second claw body 2022 and is used to lift the first ratchet 301 when the launching member 101 accumulates energy.

Exemplarily, the guide surface is an inclined shape (can be a step shape for facilitating sliding guidance of the first ratchet 301 or the like). The inclined shape is that the guide surface is provided to guide the first ratchet upward and backward as a whole along the direction of pulling the trigger member 601, where the direction of pulling the trigger member 601 is backward, and the direction along the trigger assembly 60 facing toward the gun body portion is upward. For example, under the guidance of the guide surface, the whole module of the first ratchet 301 moves backward by 12 mm and upward by 3 mm, so that the whole module moves obliquely backward and upward, so that the first ratchet 301 buckles the second claw body 2022 of the first claw buckle 202, and then the first claw body 2021 is released from the claw buckle groove 1011 of the launching member 101, and the launching of the toy 80 is completed.

In the above implementing process, by arranging the guide member 701 inside the gun shell 70, when the trigger assembly 60 is pulled, the first ratchet 301 can move backward and upward along the guide surface of the guide member 701, and then gradually lift the second claw body 2022, and drive the first claw body 2021 to rotate until the launching member 101 is released. The embodiment has a simple structure, and does not need to separately provide complicated design structures such as special-shaped grooves and pins on the first ratchet, so that the structure is more stable and durable and the difficulty of assembly is reduced, thereby reducing the setting arrangement of fine structures, and the structure is more integrated, which brings more firm and stable effects, and the detachment, wear and jamming of parts are not easy to occur.

In all embodiments of the present disclosure, “large” and “small” are relative, “more” and “less” are relative, and “upper” and “lower” are relative, and the expressions of such relative terms will not be described in detail in the embodiments of the present disclosure.

It is to be understood that references throughout the specification to “in this embodiment”, “in an embodiment of the present disclosure”, or “as an alternative embodiment” mean that a particular feature, structure, or characteristic related to the embodiment is comprised in at least one embodiment of the present disclosure. Therefore, the appearance of “in this embodiment”, “in an embodiment of the present disclosure”, or “as an alternative embodiment” in various places throughout the specification does not necessarily refer to the same embodiment. Furthermore, these particular features, structures, or characteristics may be incorporated in any suitable manner in one or more embodiments. Those skilled in the art should also understand that the embodiments described in the specification are all optional embodiments, and the acts and modules involved are not necessarily necessary for the present disclosure.

In various embodiments of the present disclosure, it should be understood that the size of the sequence numbers of the above-described processes does not mean the necessary order of execution, and the order of execution of each process should be determined by its function and internal logic, and should not constitute any limitation on the implementation of the embodiments of the present disclosure.

The above is merely a specific embodiment of the present disclosure, but the scope of protection of the present disclosure is not limited thereto, and any person skilled in the art can easily think of changes or substitutions within the technical scope disclosed in the present disclosure, and should be covered within the scope of protection of the present disclosure. Therefore, the scope of protection of the present disclosure should be the same as that of the claims.

What is claimed is:

1. A toy gun comprising:
a gun body portion, a bolt portion, and a handle portion, wherein an inner cavity of the gun body portion is provided with a launching member and an elastic assembly,
wherein the gun body portion further comprises:
a noise reduction assembly comprising a noise reduction ring and a noise reduction rib;
wherein the noise reduction ring is disposed on opposite sides of an inner cavity wall of the gun body portion, and the noise reduction rib is disposed on the launching member, when the launching member launches a toy, the noise reduction rib is close to and fitted to contact with the noise reduction ring, and when the elastic assembly accumulates energy on the launching member, the buffer rib is far away from the noise reduction ring;
after the noise reduction rib is fitted to contact with the noise reduction ring during a launching process, the speed of the launching member is continuously reduced to zero;
the bolt portion assists the launching member in completing energy accumulation of the toy gun through the elastic assembly; and
the handle portion comprises a trigger assembly, and when energy accumulation of the launching member is completed, the trigger assembly is pulled to trigger a launching action.

2. The toy gun according to claim 1, wherein a distance between the two noise reduction rings arranged on an inner cavity wall of the gun body portion is provided to allow and receive the toy inside the launching member to pass through, and is smaller than a maximum distance of the noise reduction ribs on two sides of the launching member in the direction perpendicular to the launching direction.

3. The toy gun according to claim 1, wherein a bolt portion comprising a bolt member, a first claw buckle, a second claw buckle, and an adjusting assembly, wherein the bolt member is arranged on a side of the launching member away from a launching outlet of the gun body portion, the first claw buckle and the second claw buckle are coaxially rotatably connected to the bolt member, the first claw buckle comprises a first claw body and a second claw body, and when the first claw body is employed for the launching member to accumulates energy, the launching member is pulled to move in a direction away from launching the toy, the adjusting assembly is connected to the bolt member, and one end of the adjusting assembly is abutted against the second claw buckle.

4. The toy gun according to claim 3, wherein an inner cavity of the gun body portion of the toy gun further comprises an engaging portion comprising first ratchet and second ratchet, the first ratchet is fitted with the second claw body, and the second ratchet is fitted with the second claw buckle;
wherein when the launching member launches the toy, the first ratchet moves in a direction close to the second claw body to drive the first claw buckle to rotate about the bolt member to drive the first claw body release the launching member, and
when a launching distance of the launching member is adjusted, the adjusting assembly drives the second claw buckle to rotate about the bolt member, the second claw buckle is disengaged from the second ratchet and moves forward and backward along the launching direction of the launching member to fit with the second ratchet at a predetermined position.

5. The toy gun according to claim 4, comprising at least two sets of elastic assemblies, wherein each set of elastic assemblies has at least one elastic member, one end of the elastic member is connected to the launching member, and the other end is connected to a fixed point in the inner cavity of the gun body portion.

6. The toy gun according to claim 4, wherein one side of the launching member facing away from the cavity is configured with a claw buckle groove, when the launching member accumulates energy, the claw buckle groove is configured to fit with the first claw body, and when the launching member launches the toy, the claw buckle groove is disengaged from the first claw body.

7. The toy gun according to claim 4, wherein one end of the trigger assembly is in contact with one side of the first ratchet facing away from the second claw body, and when the trigger assembly is pulled, the first ratchet is driven to move in an inclined backward and upward direction of the gun body portion.

8. The toy gun according to claim 5, wherein a guide member is further disposed in the inner cavity of the gun body portion, and the guide member is disposed with a guide surface configured to contact one side of the first ratchet facing away from the second claw body for guiding and lifting the first ratchet when the trigger assembly is pulled to launch, so that the first ratchet pulls the second claw body of the first claw buckle, and the first claw body is released from the claw buckle groove of the launching member to complete launching the toy.

9. The toy gun according to claim 8, wherein the guide surface is inclined or stepped.

10. The toy gun according to claim 4, wherein the guide surface guides the first ratchet in upward and backward direction, a direction of pulling the trigger member is backward, and a direction along the trigger assembly facing toward the gun body portion is upward.

11. The toy gun according to claim 10, wherein at least two blocking strips are provided at the launching outlet and have elastic deformation resistance, and elastic deformation resistance of each of the blocking strips is greater than self-weight of the toy and less than impact force when the toy is launched by the launching member.

12. A toy gun comprising:
a gun body portion, a bolt portion, and a handle portion, wherein an inner cavity of the gun body portion comprises a launching member and an elastic assembly;
wherein the gun body portion further comprises:
a noise reduction assembly comprising a noise reduction ring and a noise reduction rib, wherein the noise reduction ring is disposed on opposite sides of an inner cavity wall of the gun body portion, and the noise reduction rib is disposed on the launching member;
wherein when the launching member launches a toy, the noise reduction rib is close to and fitted to contact with the noise reduction ring, and when the elastic assembly accumulates energy on the launching member, the noise reduction rib is far away from the noise reduction ring;
wherein the elastic assembly comprises an energy accumulation member, a plurality of pulley components, and a second guide pulley, the energy accumulation member is wound to the pulley components and the second guide pulley, the pulley components are further provided on the launching member, and the pulley components on the launching member moves together with the launching member when pulled to accumulates energy or launching;
the bolt portion assists the launching member in completing energy accumulation of the toy gun through the elastic assembly; and
the handle portion comprises a trigger assembly, and when the energy accumulation of the launching member is completed, the trigger assembly is pulled to trigger a launching action.

13. The toy gun according to claim 12, wherein one end of each of the energy accumulation member is fixedly connected to one end of the bolt portion, extended from the end of the bolt portion to one or more pulleys provided on an inner wall of the guy shell, wound over the pulleys on the launching member, and extended to a fixed connection point in the inner cavity of the gun body portion; and
the plurality of pulleys is to extend a length of the energy accumulation member.

14. The toy gun according to claim 12, wherein a bolt portion comprising a bolt member, a first claw buckle, a second claw buckle, and an adjusting assembly, wherein the bolt member is arranged on a side of the launching member away from a launching outlet of the gun body portion, the first claw buckle and the second claw buckle are coaxially rotatably connected to the bolt member, the first claw buckle comprises a first claw body and a second claw body, and when the first claw body is employed for the launching member to accumulates energy, the launching member is pulled to move in a direction away from launching the toy, the adjusting assembly is connected to the bolt member, and one end of the adjusting assembly is abutted against the second claw buckle.

15. The toy gun according to claim 14, wherein an inner cavity of the gun body portion of the toy gun further comprises an engaging portion comprising first ratchet and second ratchet, the first ratchet is fitted with the second claw body, and the second ratchet is fitted with the second claw buckle;
wherein when the launching member launches the toy, the first ratchet moves in a direction close to the second claw body to drive the first claw buckle to rotate about the bolt member to drive the first claw body release the launching member, and
when a launching distance of the launching member is adjusted, the adjusting assembly drives the second claw buckle to rotate about the bolt member, the second claw buckle is disengaged from the second ratchet and moves forward and backward along the launching direction of the launching member to fit with the second ratchet at a predetermined position.

16. The toy gun according to claim 15, comprising at least two sets of elastic assemblies, wherein each set of elastic assemblies has at least one elastic member, one end of the elastic member is connected to the launching member, and the other end is connected to a fixed point in the inner cavity of the gun body portion.

17. The toy gun according to claim 15, wherein one side of the launching member facing away from the cavity is configured with a claw buckle groove, when the launching member accumulates energy, the claw buckle groove is configured to fit with the first claw body, and when the launching member launches the toy, the claw buckle groove is disengaged from the first claw body.

18. The toy gun according to claim 15, wherein one end of the trigger assembly is in contact with one side of the first ratchet facing away from the second claw body, and when the trigger assembly is pulled, the first ratchet is driven to move in an inclined backward and upward direction of the gun body portion.

19. The toy gun according to claim 16, wherein a guide member is further disposed in the inner cavity of the gun body portion, and the guide member is disposed with a guide surface configured to contact one side of the first ratchet facing away from the second claw body for guiding and lifting the first ratchet when the trigger assembly is pulled to launch, so that the first ratchet pulls the second claw body of the first claw buckle, and the first claw body is released from the claw buckle groove of the launching member to complete launching the toy.

20. The toy gun according to claim 19, wherein the guide surface is inclined or stepped.
